(19) United States
(12) Patent Application Publication
(10) Pub. No.: US 2025/0209386 A1
(43) Pub. Date: Jun. 26, 2025

(54) TIME DOMAIN NMR FOR OBTAINING CETANE NUMBER OF LIQUID FUELS

(71) Applicant: UNIVERSITY OF SOUTH CAROLINA, COLUMBIA, SC (US)

(72) Inventors: AUSTIN DOWNEY, COLUMBIA, SC (US); SANG HEE WON, COLUMBIA, SC (US)

(21) Appl. No.: 18/890,868

(22) Filed: Sep. 20, 2024

Related U.S. Application Data
(60) Provisional application No. 63/556,945, filed on Feb. 23, 2024.
(60) Provisional application No. 63/613,089, filed on Dec. 21, 2023.

(51) Int. Cl. G06N 20/20

(52) U.S. Cl. CPC G06N 20/20

(57) ABSTRACT

The disclosure deals with a system and methodology for using a time-domain nuclear magnetic resonance (TD-NMR) system to measure the T2 relaxation curve of a sample, such as liquid hydrocarbon fuels. A machine-learned (ML) model is trained to predict a Derived Cetane Number (DCN) for the sample, based on the T2 relaxation curve data of the sample. The TD-NMR system is compact and can be placed in situ in a fuel system to predict the DCN of the stored fuel, to allow an operator to adapt operation of a corresponding engine accordingly, for maximized performance in real time. The ML Model can be trained using selected structural data features of the T2 relaxation curves, to bias the ML model for better working with either of hydrocarbon samples or jet fuel samples, or optimized to work with unknown samples.

### PRIORITY CLAIM

The present application claims the benefit of priority of U.S. Provisional Patent Application No. 63/613,089, filed Dec. 21, 2023, and the benefit of priority of U.S. Provisional Patent Application No. 63/556,945, filed Feb. 23, 2024, both of which are titled Time Domain NMR for Obtaining Cetane Number of Liquid Fuels, and both of which are fully incorporated herein by reference for all purposes.

### STATEMENT REGARDING SPONSORED RESEARCH OR DEVELOPMENT

This invention was made with Government support under Contract No. W911NF21-1-0306, awarded by the US Army Research Office. The Government has certain rights in the invention.

### BACKGROUND OF THE PRESENTLY DISCLOSED SUBJECT MATTER

### 1.0 Background and Introduction

Jet fuels play a critical role in the aviation industry, serving as the primary source of energy for aircraft engines. Even with advances in all-electric aircraft, combustion engines that rely on liquid hydrocarbon fuels derived from natural gas, petroleum, coal, and other sustainable sources will remain dominant for decades or perhaps the century [1, 2]. One of the key parameters that defines the ignition characteristics and combustion behavior of jet fuels is the Derived Cetane Number (DCN). The DCN provides an indication of the fuel's ignition delay and combustion quality, influencing factors such as combustion efficiency, emissions, and overall engine performance [3].

The standard method to determine cetane number is by using a cetane engine test, which is a single-cylinder engine that can be adjusted to find the ignition characteristics of the diesel fuel sample. The results are compared against mixtures of two reference fuel compounds, n-cetane (which has a cetane number of 100) and heptamethyl nonane or alpha-methyl naphthalene (with a cetane number of 0), to establish the cetane number of the fuel.

However, testing with a cetane engine is expensive and time-consuming. Therefore, the Derived Cetane Number is often calculated using alternative methods such as the Ignition Quality Tester (IQT), which is a laboratory test method that measures the ignition delay time and calculates a DCN. The DCN is a calculated value based on the ignition delay and is intended to correlate with the true cetane number.

Traditionally, the DCN of jet fuels has been determined using laboratory-based methods, such as ASTM D7768 [4], D7170 [5], and D6890 [6]. These methods utilize combustion chambers and require large sample sizes, time-consuming measurements, and expensive equipment, making them impractical for on-site or real-time monitoring. However, recent advancements in analytical techniques have explored alternative approaches for DCN prediction, including NMR spectroscopy [7] and infrared (IR) spectroscopy [8, 9, 3]. These methods leverage the unique molecular fingerprints of jet fuels to correlate spectral features with DCN values. While NMR spectroscopy provides valuable insights into the molecular composition of the sample, IR spectroscopy focuses on the vibrational modes of the molecules. Despite their effectiveness, these techniques often require bulky instruments and complex data analysis procedures, limiting their applicability in portable and real-time scenarios.

The T2 relaxation curve characterizes the decay of nuclear magnetization in a sample [10]. By analyzing the T2 relaxation curve, valuable insights can be gained into the molecular composition and physical properties of the sample, including the DCN [11].

The cetane or Derived Cetane Number is crucial for diesel engines because it affects engine performance, emissions, and cold starting characteristics. Fuels with higher cetane numbers provide for a more controlled and complete burn, reducing harmful emissions and improving engine operation. Conversely, fuels with lower cetane numbers may lead to rough engine operation, increased emissions, and difficulties with cold starts.

### SUMMARY OF THE PRESENTLY DISCLOSED SUBJECT MATTER

The presently disclosed system and corresponding and/or associated methodology, generally relates to measuring a Derived Cetane Number (DCN) in situ in a fuel system. In various aspects, presently disclosed subject matter relates to time domain NMR for obtaining cetane number of liquid fuels. For some presently disclosed embodiments, present subject matter relates to predicting DCN for jet fuels using compact NMR.

We have developed a low-cost time-domain Nuclear Magnetic Resonance (NMR) spectroscopy system for field deployable applications, such as on a diesel engine, that can be used for taking T2 relaxation times of fuels. Using these T2 relaxation times and functional chemical group analysis, we can obtain the Derived Cetane Number (DCN). This enables inline testing of fuels to obtain the DCN, a first in the field we believe. This means we could build sensors and deploy them to ships, airplanes, and heavy equipment to understand how the fuel will ignite in real-time. In comparison, this number is usually obtained in labs using equipment that requires burning the fuel. Initially, NMR can generally be used for determining the content and purity of a sample along with its molecular structure. The specific methodology presently disclosed allows for obtaining the Derived Cetane Number (DCN) for a particular fuel sample.

The disclosed system can enable engines to run more efficiently and for longer with less emissions. It could enable engine management systems to provide better control when burning very dirty fuels (like sea-going ships) or obtain better predictive maintenance values.

NMR spectroscopy is a well-established technique that exploits the inherent magnetic properties of atomic nuclei to provide detailed molecular information about a sample. Time-domain nuclear magnetic resonance (TD-NMR) is a compact and versatile variant of NMR spectroscopy that enables the measurement of the T2 relaxation curve, which characterizes the decay of nuclear magnetization in a sample.

By analyzing the T2 relaxation curve using machine learning (ML) algorithms and simple regression techniques, valuable insights can be gained into the molecular composition and physical properties of the sample, including the DCN.

The ability to predict the DCN of jet fuels using a custom, compact TD-NMR system offers several significant advantages. Firstly, it provides a rapid and efficient method for evaluating the ignition characteristics of jet fuels, enabling real-time monitoring and quality control during fuel production and use. The compact nature of the TD-NMR system allows for portability, making it suitable for on-site or even in-situ measurements within an aircraft. Comparing to ASTM standards, sample sizes with this method can be reduced from 100-400 mL to as small as 0.1 mL, and the time for data collection is lowered from 20-30 min to under 1 min [4, 5, 6].

The predictive power of ML algorithms in analyzing T2 relaxation data enables the detection of subtle variations in fuel composition and aging, which can impact the DCN. ML techniques have been successfully implemented in the interest of predicting cetane number and DCN for a large array of jet fuels, but the predictions are created using NMR spectroscopic data [12], physical properties of the fuels [13], and functional group data [14]. By training the ML models with a diverse dataset of information from jet fuels and corresponding DCN values, the system can learn complex relationships and patterns, allowing accurate predictions of DCN values for previously unseen samples.

Presently disclosed subject matter uses the T2 relaxation curves of jet fuels and a ML model to predict DCN. Although T2 curves contain structural information, it can often be difficult to interpret due to conditions that vary with each system, such as magnetic homogeneity and signal filtering. However, using ML techniques it can become much easier to interpret the data and extract features. Understanding the importance of each feature is crucial for prioritizing and selecting the most influential variables, further improving the performance and interpretability of the model. Random forests are particularly well-suited for handling complex relationships and interactions within the data, making them effective in capturing the intricate patterns between the T2 relaxation curve and DCN values. The algorithm leverages the collective decision-making of the trees to provide robust predictions and estimate uncertainties associated with the DCN values.

The presently disclosed subject matter describes the exemplary custom TD-NMR system capable of rapidly acquiring relaxation data from liquid samples with high repeatability and containing vital structural information; and evaluates the performance of a ML algorithm in analyzing relaxation data and predicting the DCN, such as for 10 pure hydrocarbon samples and 10 jet fuel samples.

In some exemplary embodiments disclosed herewith, systems and methods for time domain NMR for obtaining cetane number of liquid fuels are described.

It is to be understood that the presently disclosed subject matter equally relates to systems and to associated and/or corresponding methodologies. One exemplary such method relates to methodology for obtaining the Derived Cetane Number (DCN) of liquid fuels. Such exemplary methodology preferably comprises using a time-domain nuclear magnetic resonance (TD-NMR) system for measuring the T2 relaxation curve data of a target liquid fuel; training a machine-learned (ML) model to predict a Derived Cetane Number (DCN) for liquid fuels, based on the T2 relaxation curve data of a plurality of sample liquid fuels; inputting the measured T2 relaxation curve data of a target liquid fuel from the TD-NMR system into the ML model; and receiving as an output of the ML model a prediction of the DCN of the target liquid fuel.

Other example aspects of the present disclosure are directed to systems, apparatus, tangible, non-transitory computer-readable media, user interfaces, memory devices, and electronic devices for time domain NMR for obtaining cetane number of liquid fuels. To implement methodology and technology herewith, one or more processors may be provided, programmed to perform the steps and functions as called for by the presently disclosed subject matter, as will be understood by those of ordinary skill in the art.

Another exemplary embodiment of presently disclosed subject matter relates to a computer-implemented system for obtaining the Derived Cetane Number (DCN) of liquid fuels. Such exemplary system preferably comprises a time-domain nuclear magnetic resonance (TD-NMR) system for measuring the T2 relaxation curve data of a target liquid fuel; a machine-learned (ML) model trained to predict a Derived Cetane Number (DCN) for liquid fuels, based on the T2 relaxation curve data of a plurality of sample liquid fuels; one or more processors; and one or more non-transitory computer-readable media that store instructions that, when executed by the one or more processors, cause the one or more processors to perform operations. Such exemplary operations preferably comprise inputting the measured T2 relaxation curve data of a target liquid fuel from the TD-NMR system into the ML model; and receiving as an output of the ML model a prediction of the DCN of the target liquid fuel.

Per another exemplary embodiment of presently disclosed subject matter, one or more tangible, non-transitory computer-readable media that collectively store instructions that, when executed, cause a Derived Cetane Number (DCN) detector system for liquid fuels to perform operations. Such exemplary operations preferably comprise using a time-domain nuclear magnetic resonance (TD-NMR) system for measuring the T2 relaxation curve data of a target liquid fuel; inputting the measured T2 relaxation curve data of a target liquid fuel from the TD-NMR system into a machine-learned (ML) model trained to predict a Derived Cetane Number (DCN) for liquid fuels, based on the T2 relaxation curve data of a plurality of sample liquid fuels; and receiving as an output of the ML model a prediction of the DCN of the target liquid fuel.

Additional objects and advantages of the presently disclosed subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments, uses, and practices of the presently disclosed subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the presently disclosed subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the presently disclosed subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification, and will appreciate that the presently disclosed subject matter applies equally to corresponding methodologies as associated with practice of any of the present exemplary devices, and vice versa.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1(a) illustrates an exemplary embodiment of a presently disclosed full compact Nuclear Magnetic Resonance (NMR) spectroscopy system desktop setup, with primary components and subsystems annotated;

FIG. 1(b) illustrates a schematic of the exemplary embodiment of present FIG. 1(a), particularly representing surface mounted and external components involved in signal processing and amplification;

FIG. 2 graphically illustrates exemplary spin echoes from a sample of deionized (DI) water following the application of a Carr-Purcell-Meiboom-Gill (CPMG) pulse sequence;

FIG. 3 illustrates a table (Table 1) of ten standard, physically interpretable signal metrics which represent considered features, and their associated interpretations and formulas;

FIGS. 4(a) and 4 (b) graphically illustrate respective natural logarithm of T2 decay curves, indicating that signal quality degrades over time to eventually become indistinguishable from noise;

FIG. 5 illustrates a summary table (Table 2) of averaged out-of-bag (OOB) predictor importance estimates for both hydrocarbon and jet fuel datasets;

FIG. 6 graphically illustrates normalized partial dependence for the hydrocarbon dataset, to visualize the effect of individual predictors on the Derived Cetane Number (DCN); and

FIGS. 7(a) and 7(b) graphically illustrate visualizations of model predictions on the test dataset, for the hydrocarbon (FIG. 7(a)) and jet fuel (FIG. 7(b)) datasets, respectively.

Repeat use of reference characters in the present specification and drawings is intended to represent the same or analogous features, elements, or steps of the presently disclosed subject matter.

### DETAILED DESCRIPTION OF THE PRESENTLY DISCLOSED SUBJECT MATTER

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

In general, the present disclosure is directed to system and methodology for measuring a Derived Cetane Number (DCN) in situ in a fuel system. In various aspects, presently disclosed subject matter relates to time domain NMR for obtaining cetane number of liquid fuels.

### 2. Materials and Methods

### 2.1. System Design

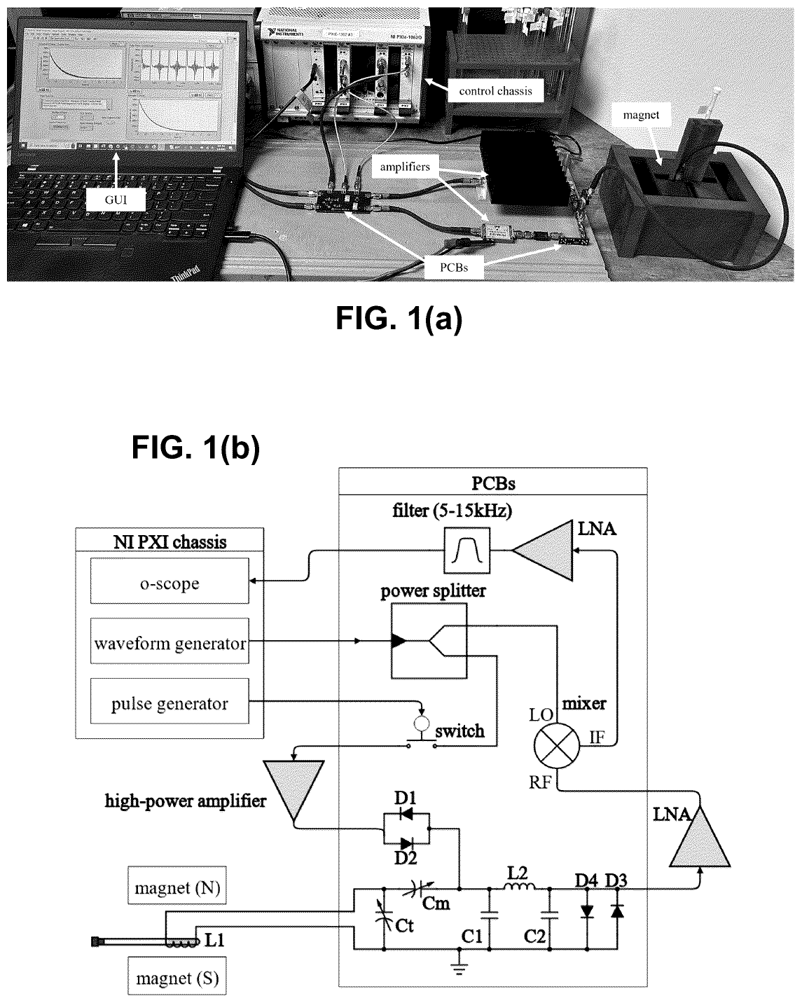

An exemplary embodiment of a full compact TD-NMR system in accordance with the presently disclosed subject matter and the schematic for the electronics and control subsystems are shown in FIGS. 1(a) and 1(b), respectively. The tasks of waveform generation, calibration to the optimal Larmor frequency, and data collection and export are performed by a LabVIEW program. This program serves as the command center for the entire system. The laptop interfaces with the system's hardware through a Thunderbolt cable, and the remainder of the custom electronics are linked to the PXI chassis via 50Ω cables. The amplification and signal routing components are mounted on printed circuit boards (PCBs), with the exception of the first-stage low-noise amplifier (LNA) and the high-power amplifier. This system is designed for analytes to be in standard 5 mm tubes.

### 2.1.1. Permanent Magnet Array

FIG. 1(a) illustrates an exemplary embodiment of a presently disclosed full compact Nuclear Magnetic Resonance (NMR) spectroscopy system desktop setup, with primary components and subsystems annotated. Thus, the configuration of the permanent magnet utilized in this system is illustrated in FIG. 1(a). It consists of two cylindrical dipole magnets enclosed by a steel yolk, resembling the design adopted by Sahebjavaher et al. [15]. The permanent magnet disks, crafted from grade N42 NdFeB material, were sourced from K & J Magnetics, Inc. These disks, with a diameter of 76.2 mm (3 in.) and a thickness of 25.4 mm (1 in.), are axially magnetized. When positioned about 15 mm apart, the bare magnets generate a measured flux density of 0.5 T. To enhance homogeneity and elevate the flux density within the gap, the disks are enclosed by 1018 carbon steel bars, each with a thickness of 19 mm. These bars serve as a return pathway for the magnetic flux and greatly boost the overall efficiency. Additionally, 1018 steel caps, 7.5 mm thick, were affixed to the magnet surfaces to further refine homogeneity. Prior to the assembly's completion, two-dimensional simulations of the magnetic field were conducted using the finite element method. These simulations, carried out with the Finite Element Method Magnetics software package, aimed to validate the anticipated enhancements [16].

Simulation can be represented featuring the bare magnets, while simulation can also showcase incorporating the steel components. Although the Finite Element Method Magnetics estimated an approximate 40% increase in flux density, the outcomes demonstrated a 29% enhancement in strength, reaching a peak of 0.645 T. Consequently, a Larmor frequency of approximately 27.5 MHz was achieved. Notably, while bolstering overall strength and uniformity, the added steel elements markedly improve the safety of the design by restricting the field lines from having any significant effect beyond the immediate volume of the magnet.

### 2.1.2. Signal Excitation and Detection Electronics

FIG. 1(b) illustrates a schematic of the exemplary embodiment of present FIG. 1(a), particularly representing surface mounted and external components involved in signal processing and amplification. Thus, the core electronics essential for NMR signal excitation and detection are visually depicted in FIG. 1(b). A single 24 V power supply serves as the system's energy source, which is then channeled into a network of uncomplicated linear regulators. These regulators adeptly step down the 24 V potential to specific levels: 12 V for the initial stage low noise amplifier (LNA), 5 V for the second stage LNA, and 1.8 V for the switch.

The excitation process initiates with a sinusoidal waveform set at −5 dBm, derived from the waveform generator, and tailored to match the optimal Larmor frequency. This signal is divided into two branches using a 2-way, 0° power divider. One branch is routed to the Local Oscillator (LO) port of a frequency mixer with a conversion loss of 4.6 dB, while the other is directed to an absorptive switch equipped with shunt legs terminated at 50Ω. The switch's state is under the control of a pulse generator, carefully synchronized with the Carr-Purcell-Meiboom-Gill (CPMG) pulse sequence to generate RF pulses as required.

The train of pulsed RF signals is then conveyed to a high-power amplifier, boosting the power to 35 dBm. These potent pulses are subsequently directed into the duplexer circuit, comprising a pi filter and crossed diodes. Engineered with lumped elements calibrated to match the Larmor frequency, the duplexer serves to shield the sensitive LNAs from potential damage due to high-power pulses. Additionally, it effectively directs most of the power toward the probe.

The probe configuration encompasses a solenoidal coil along with two adjustable tuning and matching capacitors. The solenoid, meticulously handcrafted, is composed of 8 turns of copper wire insulated with Kapton, featuring an internal diameter of 5 mm. By utilizing ceramic trimmer capacitors—one in series with the coil and another in parallel—the probe's tuning and matching can be finely adjusted to align with 50 0. This precision is crucial for optimizing power transmission to the sample and minimizing signal reflections, both of which are vital for obtaining a clear signal. The probe's quality factor (Q value), pivotal for efficient power delivery, was calculated using the formula involving the resonant frequency of the circuit (f_{c}) and the resonance width at half power (Δf). The Q value for this probe was determined to be 70, a value that balances efficient power transmission without complicating frequency optimization during scan preparation.

Subsequent to sample excitation, the microvolt-level NMR response traverses the duplexer and receives a 40 dB amplification at the first stage LNA. This signal is then subjected to frequency mixing with the original sinusoid, resulting in a decaying waveform positioned within the audio frequency range. This design choice simplifies the final amplification stage, where the signal undergoes an additional 40 dB gain before being filtered from 5-15 kHz using an operational amplifier as an active band-pass filter.

### 2.1.3. Signal Generation and Control

Within the National Instruments (NI) PXI chassis, crucial components constitute the signal generation, control, and data acquisition subsystems. PXI generally stands for PCI extensions for Instrumentation, and is based on the PCI architecture, a commonly-used standard in personal computers, with an industrial connector. In this example, specifically, the NI PXI components preferably include a pulse train generator, an arbitrary waveform generator, and a 16-bit digitizer.

The timing and coordination of waveforms are under the precise control of a LabVIEW program. The initiation of actions hinges on the rising edge of the pulse train generator, which not only triggers the switch but also initiates the sinusoidal signal that's directed into the power splitter.

In this setup, a pulse duration of 6 microseconds corresponds to a 90° flip of the sample's magnetization. The time gap separating the 90° and 180° pulses, often referred to as the “tau” value, stands at 0.625 ms. Each scan encompasses a total of 1980 pulses, collectively establishing a relaxation window spanning 2.5 seconds. To ensure complete relaxation of the sample, a 10-second relaxation delay is observed between scans. Consequently, the acquisition of four averages of a sample decay curve is accomplished in less than a minute. The LabVIEW program is configured to identify and graph the peak voltage value associated with each spin echo. These voltage values decay exponentially over time, allowing the construction of a T2 relaxation curve.

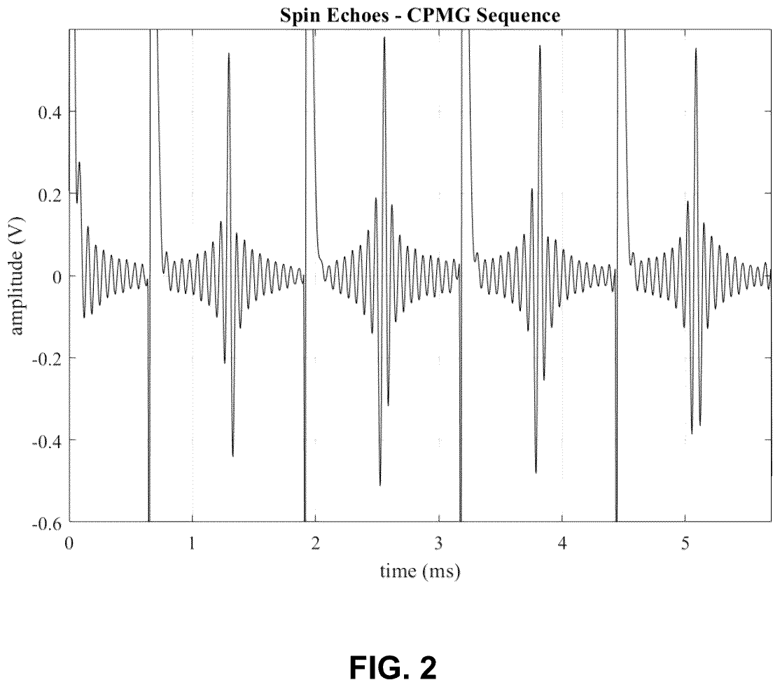

FIG. 2 graphically illustrates exemplary spin echoes from a sample of deionized (DI) water following the application of a CPMG pulse sequence. In particular, FIG. 2 displays three spin echoes captured following the application of one 90° and two 180° RF pulses. An impressive signal-to-noise ratio of 25 dB was measured for a single scan. While one might anticipate diminishing amplitudes for successive echoes in FIG. 2, initial echoes tend to exhibit amplitude fluctuations. These fluctuations arise due to phase discrepancies in the 90 and 180 RF pulses and inherent system noise. However, such fluctuations diminish considerably after several successive 180-degree pulses, thanks to phase normalization. Furthermore, the process is refined by averaging multiple scans, ultimately culminating in the creation of the final decay curve. To streamline user interaction, a graphical user interface (GUI) has been developed. This GUI serves as the front end, enabling users to adjust parameters, view acquired decay curves, and export data for subsequent analysis.

It's important to note that the system's magnetic field strength is influenced by a temperature shift gradient of-800 ppm/K. Consequently, the LabVIEW program undertakes an essential task before each scan: finding the optimal operating frequency. This is achieved through a profile that correlates the current temperature, measured by a thermocouple, with the Larmor frequency. Based on this profile, the program selects the appropriate frequency, ensuring precise data acquisition.

### 3. Experiments/Tests

### 3.1. H/C Ratio

A portion of testing relative to the presently disclosed subject matter may consider relationship of the Derived Cetane Number and hydrogen/carbon ratio from infrared spectroscopic data.

### 3.2. T2 Relaxation

A portion of testing relative to the presently disclosed subject matter may consider the relationships of T2 relaxation curves, which characterize the decay of nuclear magnetization in a sample [10]. By analyzing the T2 relaxation curve, valuable insights can be gained into the molecular composition and physical properties of the sample [11].

### 4. Data Analysis

While prediction of DCN for jet fuels has been the subject of much research, no instances in the literature have been identified that do so using T2 relaxometry alone. This is likely due to the relatively poor resolution of relaxometric measurements gathered from low-field NMR in comparison to the high-resolution spectra obtainable via different modes of spectroscopy. It is understood that initial signal strength and T2 decay rate correlate with sample hydrogen content and chemical shape, respectively, but beyond these two metrics it is unclear what features might be of use for T2-based predictive schemes. With machine learning (ML) and data mining effectively all pervasive in scientific inquiry as of the last few decades, it is no surprise that approaches diverging from pure statistics are being applied to tackle challenges akin to that aforementioned. Date et al. introduce a pattern recognition and feature extraction method for T2 relaxation curves using a handful of different standard ML approaches. Work like that by Peng uses both T1 and T2 relaxometric measurements along with ML models for classification of oil samples. Although similar in vein, the motivation of our subsequent analysis is twofold. Firstly—while maintaining interpretability—we pursue features beyond T2 curve amplitude and decay rate they may be used as predictors in DCN regression models. Secondly, we wish to quantify the relative importance of different features as predictors for DCN.

### 4.1. Machine Learning Features

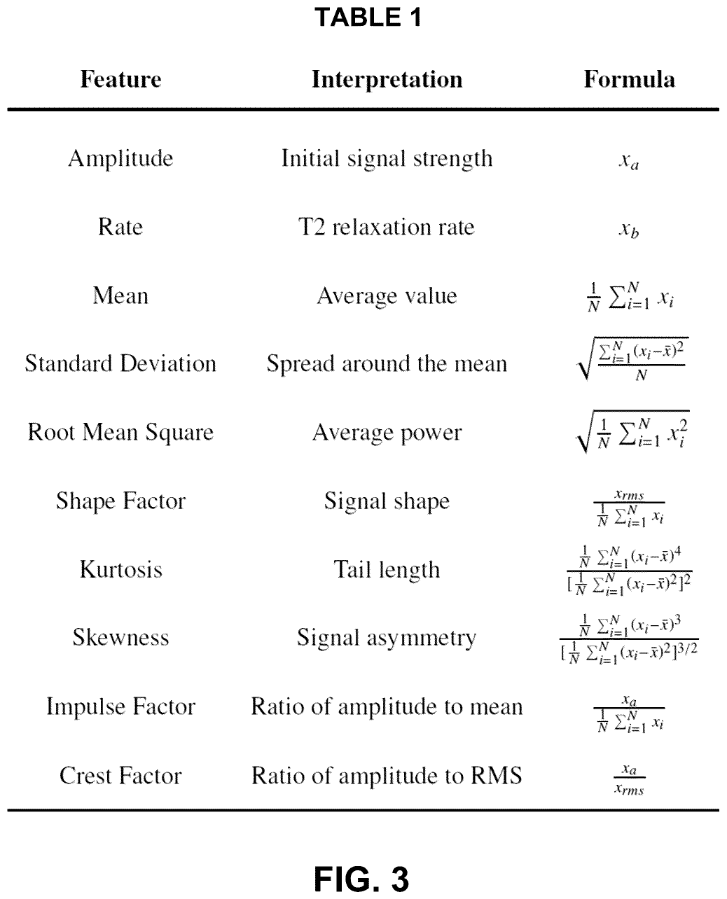

Feature extraction and importance estimations are performed with two datasets, one a collection of 12 different hydrocarbons and another of 15 different jet fuels. All samples are probed thrice using our compact NMR setup, each time on a different date for consistency. To augment, like signals are averaged together; this generates new data to which we assign the same response as its constituents. Overall, 72 total hydrocarbon T2 curves (36 averaged) and 90 total jet fuel T2 curves (45 averaged) are produced. Exponentials of the form y=ae^{bt} are fitted and the ten standard, physically interpretable signal metrics detailed in FIG. 3 (which is Table 1) are computed. In other words, FIG. 3 illustrates a table (Table 1) of ten standard, physically interpretable signal metrics which represent considered features, and their associated interpretations and formulas. There, x is the sequence of induced voltages gathered from a sample's T2 curve.

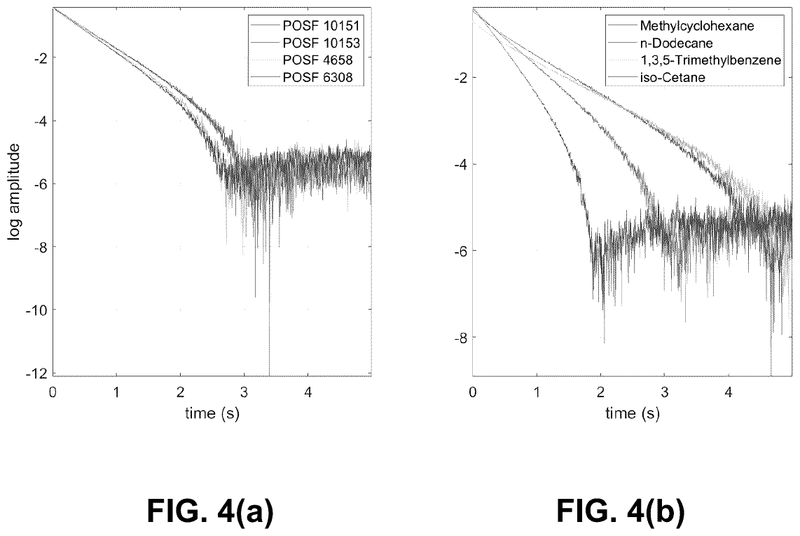

We note that not the entire duration of a signal is considered for feature computation. FIGS. 4(a) and 4(b) graphically illustrate respective natural logarithm of T2 decay curves. Looking at the natural logarithm of T2 decay in FIGS. 4(a) and 4(b), it is clear signal quality degrades in time and eventually becomes indistinguishable from noise. While the time nonlinear behavior energies vary due to diversity in sample decay rates, the logarithmic amplitude remains constant. As such, we loop over fractions of initial signal strength for each sample and compute features over only a portion of raw signals. By doing so, we expect to fit exponentials with smaller error and compute features more meaningful over the entirety of a treated signal.

Model-wise, random forests are chosen not only for their high levels of interpretability but also for their favorable performance on small amounts of data. Ensembles of regression trees are fitted separately to hydrocarbon and jet fuel datasets as to capture any underlying differences in their feature space. For comparison, predictors are split at each node using both curvature and interaction techniques. The curvature algorithm performs a chi-square test of independence between all features and the response, picking the feature that minimizes p-value. The interaction algorithm does the same while also performing a chi-square test of independence between a given feature and all other features, picking the one that minimizes p-value for both. Coupling the small size of used datasets with limited variance in response, we adopt a leaf size of just one. Feature importance is estimated by permuting out-of-bag (OOB) observations for a given model and detailing changes in DCN. The more permutation of feature observations affects model response, the more important a feature is deemed to be. Training loops are implemented in MATLAB by way of the Curve Fitting and Statistics and Machine Learning toolboxes and have the following form:
1. Loop over forest size
2. Loop over fraction of raw decay data
3. Compute features
4. Grow random forest
5. Save out-of-bag (OOB) permuted feature importance

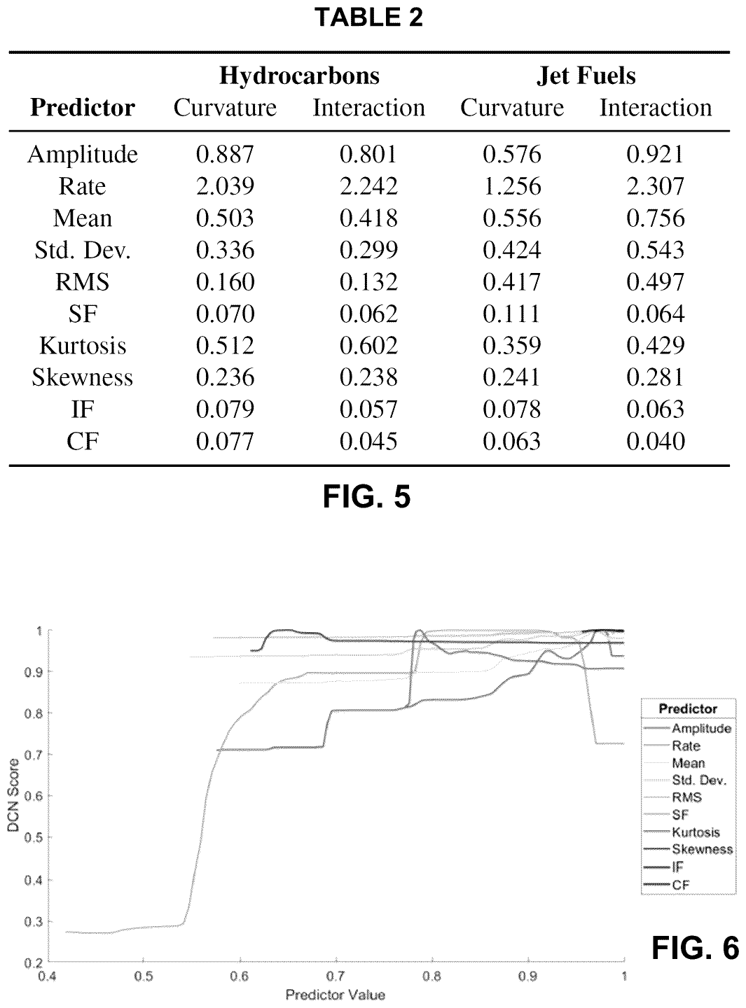

Upon completion of a full training loop, feature importance estimates are averaged across all models. This aggregation is in an effort to capture general trends in the data unbiased to forest size or the fraction of decay data fitted to. FIG. 5 illustrates a summary table (Table 2) of averaged out-of-bag (OOB) predictor importance estimates for both hydrocarbon and jet fuel datasets. In either case, decay rate information appears as the most important predictor of DCN. This is followed second and third by initial signal strength (amplitude) and mean, respectively. Highly correlated features like shape factor, impulse factor, and crest factor receive similar, small importance estimates. At this point, we notice and draw attention to differences between the datasets. For example, while kurtosis acts as a reasonable predictor in both, it constitutes a larger fraction of overall feature importance for hydrocarbons. Similar is the case for standard deviation and root mean square albeit for jet fuels. Regressing fuel DCN from the investigated T2-features, then, we suppose two main approaches. One may first consider using only those features identified as significant for jet fuels. While a corresponding model may perform well on select classes of fuels, we suspect this approach is too naive. Alternatively, one can select a combination of those features estimated as influential for both hydrocarbons and jet fuels. Though more expensive—considering that most fuels are hydrocarbon derived—this sort of model has a better chance of generalizing. In any case, much overlap is observed between hydrocarbon and jet fuel DCN predictor importance, so we anticipate there is an equilibrium to be struck between model feature-complexity and overall performance.

FIG. 6 graphically illustrates normalized partial dependence for the hydrocarbon dataset, to visualize the effect of individual predictors on the Derived Cetane Number (DCN). Like feature importance estimates, partial dependence is calculated for each predictor at every iteration through training loops. Results are averaged together and plotted on the same set of axes for concision. The horizontal axis displays predictor values, normalized so that differing variances among features are not exacerbated. The vertical axis displays model output, also normalized as to capture trends in DCN. FIG. 6 elucidates findings in FIG. 5 (which is Table 2). Notably, decay rate information not only varies most among samples, but it also performs best at driving changes in our response variable.

### 4.2. DCN Regression Analysis

As noted above, ensembles of regression trees are fitted separately to hydrocarbon and jet fuel datasets so as to capture any underlying differences in their feature space.

### 4.3. Feature Sensitivity Analysis

Using T2 relaxation times as obtained per presently disclosed subject matter and functional chemical group analysis, we can obtain the Derived Cetane Number (DCN). It is understood that initial signal strength and T2 decay rate correlate with sample hydrogen content and chemical shape, respectively. This enables inline testing of fuels to obtain the DCN.

### 5. Results/Discussion

### 5.1. Prediction Via Random Forests

Informed by feature importance estimates, we grow ensembles of regression trees for DCN prediction. Hydrocarbon and jet fuel T2 data detailed in 4.1 is collected and shuffled as to curate a single training dataset consisting of 162 observations. Like before, fitting loops are employed to identify both the optimal fraction of raw signal to consider for feature computation as well as the forest size that yields best performance. A test dataset is generated by probing twice five different, randomly selected hydrocarbon and jet fuel samples that appear in our training dataset. Model performance is compared on the basis of root mean square error (RMSE), the formula for which is provided below.

$$RMSE = \sqrt{\frac{{\sum }_{i = 1}^{N} {( {y}_{i} - {\hat{y}}_{i} )}^{2}}{N}} \qquad ( 1 )$$

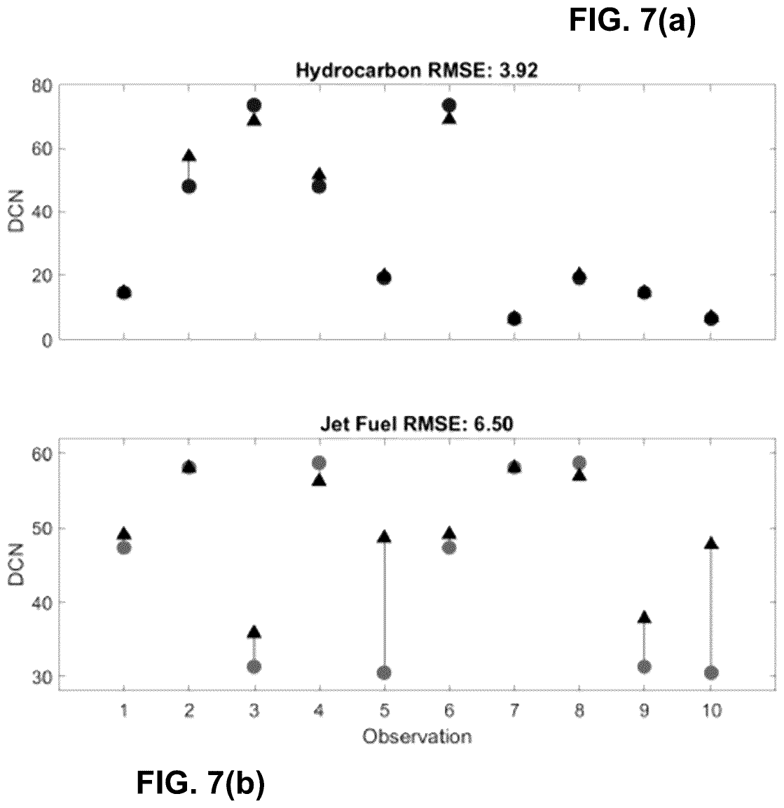

For reference, first we train using only initial signal strength and decay rate information as features. We obtain corresponding baseline RMSE values of 4.61 and 7.09 for the hydrocarbons and jet fuels present in our test dataset, respectively. As anticipated from previous analysis, however, model performance depends greatly on feature selection. This is exemplified by a reduction in RMSE for hydrocarbon predictions to just 3.92 following training on signal amplitude, decay rate, mean, and kurtosis. Similarly, RMSE for prediction on jet fuels is reduced to 6.50 by fitting to signal amplitude, decay rate, mean, and standard deviation. FIGS. 7(a) and 7(b) graphically illustrate visualizations of model predictions on the test dataset, for the hydrocarbon (FIG. 7(a)) and jet fuel (FIG. 7(b)) datasets, respectively.

While growing forests, we observe two notable patterns across models. Compared to DCN prediction for hydrocarbons, jet fuel models: (1) systematically produce larger OOB error and RMSE and (2) display greater sensitivity to feature selection. Together, these findings suggest that DCN regression for jet fuels is generally a more technically demanding task than it is for pure hydrocarbons. Although much of jet fuel RMSE in the test dataset arises from inaccurate predictions on a particular sample, the discrepancy between hydrocarbon and fuel regression difficulty can be explained probably by complex interactions which take place upon conglomeration of different hydrocarbons for fuel synthesis. In general, DCN regression from T2 data exhibits much sensitivity in same-sample parameter differences arising from slight irregularity in setup conditions. In fact, instances are observed during training and testing where a given model outputs different DCN values for the same hydrocarbon or fuel. Albeit somewhat a consequence of limited training data and small leaf size, this complication is one we seek to address in the future but is beyond the scope of this disclosure.

Lastly, we note in passing that while truncating signals after decaying to between 13% and 15% of their initial strength yields lowest RMSE for prediction on hydrocarbons, a range between 23% and 25% yields lowest RMSE for jet fuels. Although it may generally be true that a lesser fraction of T2 curves are required for hydrocarbon DCN prediction, we recognize that the precise range which optimizes jet fuel projections is almost certainly dependent on the NMR instrument itself. That being said, identifying such a range for any particular setup is a parameter that can be optimized in a straightforward manner.

This written description uses examples to disclose the presently disclosed subject matter, including the best mode, and also to enable any person skilled in the art to practice the presently disclosed subject matter, including making and using any devices or systems and performing any incorporated methods. The patentable scope of the presently disclosed subject matter is defined by the claims, and may include other examples that occur to those skilled in the art. Such other examples are intended to be within the scope of the claims if they include structural and/or step elements that do not differ from the literal language of the claims, or if they include equivalent structural and/or elements with insubstantial differences from the literal languages of the claims. In any event, while certain embodiments of the disclosed subject matter have been described using specific terms, such description is for illustrative purposes only, and it is to be understood that changes and variations may be made without departing from the spirit or scope of the subject matter. Also, for purposes of the present disclosure, the terms “a” or “an” entity or object refers to one or more of such entity or object. Accordingly, the terms “a”, “an”, “one or more,” and “at least one” can be used interchangeably herein.

### REFERENCES

[1] D. Carpenter, S. Nates, F. L. Dryer, S. H. Won, Evaluating ignition propensity of high cycloparaffinic content alternative jet fuel by a chemical functional group approach, Combustion and Flame 223 (2021) 243-253. doi: https://doi.org/10.1016/j.combustflame.2020.09.024.
[2] F. L. Dryer, Chemical kinetic and combustion characteristics of transportation fuels, Proceedings of the Combustion Institute 35 (1) (2015) 117-144. doi: https://doi.org/10.1016/j.fuel.2014.09.008
[3] Y. Wang, Y. Cao, W. Wei, D. F. Davidson, R. K. Hanson, A new method of estimating derived cetane number for hydrocarbon fuels, Fuel 241 (2019) 319-326. doi: https://doi.org/10.1016/j.fuel.2018.12.027
[4] ASTM D7668-17 (2017) Standard Test Method for Determination of Derived Cetane Number (DCN) of Diesel Fuel Oils—Ignition Delay and Combustion Delay Using a Constant Volume Combustion Chamber Method, American Society for Testing Materials: West Conshohocken, PA, 2022.
[5] ASTM D7170-16 (2016) Standard Test Method for Determination of Derived Cetane Number (DCN) of Diesel Fuel Oils—Fixed Range Injection Period, Constant Volume Combustion Chamber Method (Withdrawn 2019), American Society for Testing Materials: West Conshohocken, PA, 2017.
[6] ASTM D6890-22 (2022) Standard Test Method for Determination of Ignition Delay and Derived Cetane Number (DCN) of Diesel Fuel Oils by Combustion in a Constant Volume Chamber, American Society for Testing Materials: West Conshohocken, PA, 2016.
[7] A. G. Abdul Jameel, N. Naser, A.-H. Emwas, S. Dooley, S. M. Sarathy, Predicting fuel ignition quality using 1 h nmr spectroscopy and multiple linear regression, Energy & Fuels 30 (11) (2016) 9819-9835. arXiv: https://doi.org/10.1021/acs.energyfuels.6b01690, doi: 10.1021/acs.energyfuels.6b01690. URL https://doi.org/10.1021/acs.energyfuels.6b01690.
[8] E. Al Ibrahim, A. Farooq, Prediction of the derived cetane number and carbon/hydrogen ratio from infrared spectroscopic data, Energy & Fuels 35 (9) (2021) 8141-8152. arXiv: https://doi.org/10.1021/acs.energyfuels.0c03899, doi: 10.1021/acs.energyfuels.0c03899. URL https://doi.org/10.1021/acs.energyfuels.0c03899.
[9] A. Dalmiya, M. Sheyyab, J. M. Mehta, K. Brezinsky, P. Lynch, Derived cetane number prediction of jet fuels and their functional group surrogates using liquid phase infrared absorption, Proceedings of the Combustion Institute 39 (1) (2023) 1495-1504. doi: https://doi.org/10.1016/j.proci.2022.08.104. URL https://www.sciencedirect.com/science/article/pii/S1540748922004461.
[10] Compact Time Domain NMR Design for the Determination of Hydrogen Content in Gas Turbine Fuels, Vol. Volume 1: 24th International Conference on Advanced Vehicle Technologies (AVT) of International Design Engineering Technical Conferences and Computers and Information in Engineering Conference, v001T01A017. arXiv: https://asmedigitalcollection.asme.org/IDETC-CIE/proceedingspdf/IDETC-CIE2022/86205/V001T01A017/6942852/v001t01a017-detc2022-90023.pdf, doi: 10.1115/DETC2022-90023. URL https://doi.org/10.1115/DETC2022-90023.
[11] P. M. Santos, R. S. Amais, L. A. Colnago, Rinnan, M. R. Monteiro, Time domain-nmr combined with chemometrics analysis: An alternative tool for monitoring diesel fuel quality, Energy & Fuels 29 (4) (2015) 2299-2303. arXiv: https://doi.org/10.1021/acs.energyfuels.5b00017, doi: 10.1021/acs.energyfuels.5b00017. URL https://doi.org/10.1021/acs.energyfuels.5b00017.
[12] A. G. Abdul Jameel, V. Van Oudenhoven, A.-H. Emwas, S. M. Sarathy, Predicting octane number using nuclear magnetic resonance spectroscopy and artificial neural networks, Energy & Fuels 32 (5) (2018) 6309-6329. arXiv: https://doi.org/10.1021/acs.energyfuels.8b00556, doi: 10.1021/acs.energyfuels.8b00556. URL https://doi.org/10.1021/acs.energyfuels. 8b00556.
[13] R. Li, J. M. Herreros, A. Tsolakis, W. Yang, Machine learning regression based group contribution method for cetane and octane numbers prediction of pure fuel compounds and mixtures, Fuel 280 (2020) 118589. doi: https://doi.org/10.1016/j.fuel.2020.118589. URL https://www.sciencedirect.com/science/article/pii/S0016236120315854.
[14] A Comprehensive Model for Cetane Number Prediction Using Machine Learning, Vol. Volume 3B: Combustion, Fuels, and Emissions of Turbo Expo: Power for Land, Sea, and Air.arXiv: https://asmedigitalcollection.asme.org/GT/proceedingspdf/GT2021/84959/V03BT 04A030/6757812/v03bt04a030-gt2021-60097.pdf, doi: 10.1115/GT2021-60097.URL https://doi.org/10.1115/GT2021-60097.
[15] Using Machine Learning to Predict Derived Cetane Number and Fuel Similarity, Vol. ASME 2022 ICE Forward Conference of Internal Combustion Engine Division Fall Technical Conference. arXiv: https://asmedigitalcollection.asme.org/ICEF/proceedingspdf/ICEF2022/86540/V001T0 2A004/6950401/v001t02a004-icef2022-89295.pdf, doi: 10.1115/ICEF2022-89295. URL https://doi.org/10.1115/ICEF2022-89295.
[16] L. L. Barbosa, L. F. Montes, F. V. Kock, V. G. Morgan, A. Souza, Y.-Q. Song, E. R. Castro, Relative hydrogen index as a fast method for the simultaneous determination of physicochemical properties of petroleum fractions, Fuel 210 (2017) 41-48. doi: https://doi.org/10.1016/j.fuel.2017.08.057. URL https://www.sciencedirect.com/science/article/pii/S0016236117310426.

What is claimed is:

1. A computer-implemented methodology for obtaining the Derived Cetane Number (DCN) of liquid fuels, comprising:
using a time-domain nuclear magnetic resonance (TD-NMR) system for measuring the T2 relaxation curve data of a target liquid fuel;
training a machine-learned (ML) model to predict a Derived Cetane Number (DCN) for liquid fuels, based on the T2 relaxation curve data of a plurality of sample liquid fuels;
inputting the measured T2 relaxation curve data of a target liquid fuel from the TD-NMR system into the ML model; and
receiving as an output of the ML model a prediction of the DCN of the target liquid fuel.

2. The computer-implemented methodology according to claim 1, further comprising placing the TD-NMR system in situ in a fuel system to predict the DCN of the stored fuel.

3. The computer-implemented methodology according to claim 2, further comprising operating a corresponding engine based on the predicted DCN of associated stored fuel, for optimized corresponding engine performance.

4. The computer-implemented methodology according to claim 1, further comprising training the ML Model using selected features of the T2 relaxation curve data, to bias the ML model for better working with either of hydrocarbon samples or jet fuel samples, or optimized to work with unknown samples.

5. The computer-implemented methodology according to claim 4, wherein the ML model comprises a random forest model.

6. The computer-implemented methodology according to claim 5, wherein training the random forest model comprises implementing a training loop for curve fitting of T2 relaxation curve data having the form:
(a) Loop over forest size,
(b) Loop over fraction of raw decay data,
(c) Compute features,
(d) Grow random forest, and
(e) Save out-of-bag (OOB) permuted feature importance.

7. The computer-implemented methodology according to claim 4, wherein the selected T2 relaxation curve data features include at least one or more of Initial signal strength (“Amplitude”), T2 relaxation rate (“Rate”), Average value (“Mean”), Spread around the mean (“Standard Deviation”), Average power (“Root Mean Square (RMS)”), Signal shape (“Shape Factor”), Tail length (“Kurtosis”), Signal asymmetry (“Skewness”), Ratio of amplitude to mean (“Impulse Factor”), and Ratio of amplitude to RMS (“Crest Factor”).

8. The computer-implemented methodology according to claim 7, wherein the selected T2 relaxation curve data at least one or more feature comprises T2 relaxation rate.

9. The computer-implemented methodology according to claim 8, wherein the selected T2 relaxation curve data at least one or more features further comprise initial signal strength and mean.

10. The computer-implemented methodology according to claim 7, wherein the selected T2 relaxation curve data features comprise signal amplitude, decay rate, mean, and kurtosis, for biasing the ML model training for optimized DCN predictions for hydrocarbon fuels.

11. The computer-implemented methodology according to claim 7, wherein the selected T2 relaxation curve data features comprise signal amplitude, decay rate, mean, and standard deviation, for biasing the ML model training for optimized DCN predictions for jet fuels.

12. The computer-implemented methodology according to claim 1, further comprising adjusting the operating frequency of the TD-NMR system based on current temperature readings of the target liquid fuel at the time of measuring with the TD-NMR system.

13. A computer-implemented system for obtaining the Derived Cetane Number (DCN) of liquid fuels, comprising:
a time-domain nuclear magnetic resonance (TD-NMR) system for measuring the T2 relaxation curve data of a target liquid fuel;
a machine-learned (ML) model trained to predict a Derived Cetane Number (DCN) for liquid fuels, based on the T2 relaxation curve data of a plurality of sample liquid fuels;
one or more processors; and
one or more non-transitory computer-readable media that store instructions that, when executed by the one or more processors, cause the one or more processors to perform operations, the operations comprising:
inputting the measured T2 relaxation curve data of a target liquid fuel from the TD-NMR system into the ML model; and
receiving as an output of the ML model a prediction of the DCN of the target liquid fuel.

14. The computer-implemented system according to claim 13, wherein the TD-NMR system is placed in situ in a fuel system to predict the DCN of the stored fuel.

15. The computer-implemented system according to claim 13, wherein the ML Model is trained using selected features of the T2 relaxation curve data, to bias the ML model for better working with either of hydrocarbon samples or jet fuel samples, or optimized to work with unknown samples.

16. The computer-implemented system according to claim 15, wherein the ML model comprises a random forest model.

17. The computer-implemented system according to claim 16, wherein the random forest model is trained implementing a training loop for curve fitting of T2 relaxation curve data having the form:
(a) Loop over forest size,
(b) Loop over fraction of raw decay data,
(c) Compute features,
(d) Grow random forest, and
(e) Save out-of-bag (OOB) permuted feature importance.

18. The computer-implemented system according to claim 15, wherein the selected T2 relaxation curve data features include at least one or more of Initial signal strength (“Amplitude”), T2 relaxation rate (“Rate”), Average value (“Mean”), Spread around the mean (“Standard Deviation”), Average power (“Root Mean Square (RMS)”), Signal shape (“Shape Factor”), Tail length (“Kurtosis”), Signal asymmetry (“Skewness”), Ratio of amplitude to mean (“Impulse Factor”), and Ratio of amplitude to RMS (“Crest Factor”).

19. The computer-implemented system according to claim 18, wherein the selected T2 relaxation curve data at least one or more feature comprises T2 relaxation rate.

20. The computer-implemented system according to claim 19, wherein the selected T2 relaxation curve data at least one or more features further comprise initial signal strength and mean.

21. The computer-implemented system according to claim 18, wherein the selected T2 relaxation curve data features comprise signal amplitude, decay rate, mean, and kurtosis, for biasing the ML model training for optimized DCN predictions for hydrocarbon fuels.

22. The computer-implemented system according to claim 18, wherein the selected T2 relaxation curve data features comprise signal amplitude, decay rate, mean, and standard deviation, for biasing the ML model training for optimized DCN predictions for jet fuels.

23. The computer-implemented system according to claim 13, wherein the operating frequency of the TD-NMR system is adjusted based on current temperature readings of the target liquid fuel at the time of measuring with the TD-NMR system.

24. One or more tangible, non-transitory computer-readable media that collectively store instructions that, when executed, cause a Derived Cetane Number (DCN) detector system for liquid fuels to perform operations, the operations comprising:
using a time-domain nuclear magnetic resonance (TD-NMR) system for measuring the T2 relaxation curve data of a target liquid fuel;
inputting the measured T2 relaxation curve data of a target liquid fuel from the TD-NMR system into a machine-learned (ML) model trained to predict a Derived Cetane Number (DCN) for liquid fuels, based on the T2 relaxation curve data of a plurality of sample liquid fuels; and
receiving as an output of the ML model a prediction of the DCN of the target liquid fuel.
